(19) United States
(12) Patent Application Publication
(10) Pub. No.: US 2026/0142270 A1
(43) Pub. Date: May 21, 2026

(54) DEVICE FOR SPACING BATTERY CELLS OF A VEHICLE BATTERY PACK

(71) Applicant: VALEO SYSTEMES THERMIQUES, Le Mesnil-Saint-Denis (FR)

(72) Inventors: Julien Tissot, Le Mesnil-Saint-Denis Cedex (FR); Kamel Azzouz, Le Mesnil-Saint-Denis Cedex (FR); Moussa Nacer-Bey, Le Mesnil-Saint-Denis Cedex (FR); Julio Guerra, Le Mesnil-Saint-Denis Cedex (FR)

(73) Assignee: VALEO SYSTEMES THERMIQUES, Le Mesnil-Saint-Denis (FR)

(21) Appl. No.: 19/116,920

(22) PCT Filed: Sep. 21, 2023
(86) PCT No.: PCT/EP2023/076049

§ 371 Date: Mar. 28, 2025

(30) Foreign Application Priority Data
Sep. 29, 2022 (FR) FR2209918

(51) Int. Cl. H01M 10/6557; H01M 10/613; H01M 10/617; H01M 10/625; H01M 10/653; H01M 10/6568; H01M 50/209; H01M 50/242; H01M 50/249; H01M 50/291

(52) U.S. Cl. CPC H01M 10/6557; H01M 10/613; H01M 10/617; H01M 10/625; H01M 10/653; H01M 10/6568; H01M 50/209; H01M 50/242; H01M 50/249; H01M 50/291; H01M 2200/10

(57) ABSTRACT

A device for spacing battery cells includes a spacer in contact with adjacent large side faces of the cells and turbulators. The spacer includes a flow region which is located opposite the adjacent large side faces of the cells and extends over the majority of these large faces, and one or more ribs which form at least one forced circulation circuit of the fluid between the cells. The turbulators are present in the flow region, along the forced circulation circuit, so as to create turbulence in the flow of the heat transfer fluid between the inlet and the outlet of the forced circulation circuit. The turbulators are in relief and extend heightwise in the ribs.

### TECHNICAL FIELD

The invention relates to a device for spacing battery cells of a vehicle battery pack. The invention also relates to a device for the thermal regulation of a vehicle battery pack comprising such a device, and to a cooling facility comprising such a system.

The invention relates notably to the technical field of the thermal regulation of electrical energy storage elements, in particular battery elements, liable to release heat during their operation. The invention applies preferentially, but not exclusively, to the automotive field and more particularly to the field of electric and/or hybrid powered vehicles.

### STATE OF THE ART

The electrical energy of electric and/or hybrid powered vehicles is supplied by one or more battery packs, each of which comprises several battery cells. During their operation, the cells are caused to heat and swell, thus risking becoming damaged. In particular, one charging technique, called fast charging, consists in charging the cells at a high voltage and a high amperage, in a short time, in particular in a maximum time of about twenty minutes. This rapid charging implies a significant heating of the cells, and this heating needs to be managed.

In the field of motor vehicles, it is known practice to use a thermal regulation system, notably for cooling battery packs. Such a thermal regulation system makes it possible to modify the temperature of a battery pack, for example when starting the vehicle in cold weather, by increasing its temperature for example or, whether during driving or during a charging operation, by decreasing the temperature of the cells, which tend to warm up during use.

According to one known solution, the thermal regulation system includes a cold plate inside which circulates a cooling fluid, and which is arranged in contact with the cells that are to be cooled. It has been found that such an arrangement can lead to non-uniform cooling of the cells of the one same battery pack that is to be cooled, thus leading to a reduction in the overall performance. Such a thermal regulation system also has a high thermal resistance because of the thicknesses of material present between the cooling fluid and the cells that are to be cooled. Furthermore, this solution generally takes up considerable space.

According to another known thermal regulation solution, a dielectric fluid is atomized and directed, generally in the form of a spray, directly onto the cells, by means of a dielectric-fluid circuit and of dielectric-fluid spray nozzles or orifices. A heat exchange can then take place between the cells and the dielectric fluid which comes into direct contact with a surface of said cells. After the dielectric fluid has been sprayed onto the cells, notably in the liquid phase, the dielectric fluid can flow along the walls of said cells, and accumulate notably in a lower part of the housing receiving the battery pack that is to be thermally regulated. Such a solution is described, for example, in patent FR3077683. However, notably in the context of use in a vehicle, the cells may not necessarily be laid flat, parallel to the horizontal, but may be inclined, tilted with respect to the horizontal, so that the dielectric fluid may accumulate only on one side. The accumulated dielectric fluid is then not evenly distributed with respect to the cells. These problems may also be encountered when the vehicle is itself inclined, for example on an inclined road, or because of vibrations, due to road conditions, driving, or any other condition. In addition, this can generate greater work for a pump, for example in order to be able to suck up out of the housing the dielectric fluid that has accumulated on one side. In addition, the pump could suck in air, which could damage it.

Patent FR3060863 proposes another solution for dissipating the heat generated by the battery cells, consisting in installing a spacer between the cells so as to space them apart from each other and in blowing cooling air toward said cells. The solution proposed in said document is, however, relatively complex to produce and does not, in practice, allow uniform and optimum cooling of the cells. It has also been found that the time taken to bring the cells to a desired temperature can be relatively long.

Regulating systems comprising a housing in which a cooling fluid circulates and in which the battery pack is housed are also known. That approach achieves an exchange of heat between the cells and the cooling fluid. However, immersing the cells in a fluid does not allow uniform cooling of said cells.

The invention aims to remedy all or some of the aforementioned drawbacks. In particular, one objective of the invention is to propose a device for spacing battery cells, allowing the cells of a battery pack to be cooled more uniformly and more effectively. Another objective of the invention is to propose a thermal regulation system that makes it possible to bring the cells to the desired temperature more quickly. An additional objective of the invention is to propose a thermal regulation system which is of simple and inexpensive design and which is easy to install.

### Presentation of the Invention

The solution proposed by the invention is a device for spacing battery cells of a vehicle battery pack, including a spacer configured to be in contact with adjacent large side faces of said cells.

The spacer comprises:
a flow zone arranged to be situated opposite the adjacent large side faces of the cells and to extend over the majority of said large faces,
one or more ribs extending into the flow zone, the rib(s) being arranged so as to form at least one forced-circulation circuit for the heat-transfer fluid between said cells, preferably so that the fluid is in contact with the two adjacent large side faces of said cells, the forced-circulation circuit comprises an inlet and an outlet.

Turbulators are present in the flow zone, along the forced-circulation circuit so as to create turbulence in the flow of the heat-transfer fluid between the inlet and the outlet of said forced-circulation circuit, which turbulators are set in relief and extend in the height of the ribs.

The fact that two rotary members control the flow of fluid between the orifices in the first series, combined with the fact that the three stages can be in fluid communication, allows the number of possible operating modes to be greatly multiplied compared with the staged multi-way valves of the prior art, while at the same time maintaining radial and axial compactness. The multi-way valve in accordance with the invention allows, for example, four three-way valves or three four-way valves to be combined. Also, the use of three different rotary members allows each of them to be designed in a specific manner so as to offer very simply all the combinations suitable for the required operating modes.

Other advantageous features of the invention (in its various aspects) are listed hereinbelow. Each of these features may be considered alone or in combination with the notable features defined hereinabove. Each of these features contributes, as appropriate, to solving specific technical problems defined earlier on in the description, to which problems the other features defined hereinabove do not necessarily contribute. The following features may thus, as appropriate, form the subject matter of one or more divisional patent applications:
According to one embodiment, the turbulators are arranged on one or more supports distinct from the spacer and are added into the forced-circulation circuit.
According to another embodiment, the turbulators and the spacer together form a single-piece component.
According to one embodiment, the turbulators and/or rib(s) are arranged on a support configured to be attached to a cell.

Another aspect of the invention concerns a system for the thermal regulation of a vehicle battery pack, comprising:
a housing comprising a circuit for circulating heat-transfer fluid, which housing is suitable for housing a battery pack, which pack comprises at least two battery cells of generally parallelepipedal shape each having two large side faces, which cells are adjacent at one of their large side faces,
a device for spacing the cells in accordance with one of the preceding features.

According to one embodiment, the turbulators and/or the rib(s) are formed in the wall of at least one large side face of the cells, preferably in each of the walls of the two large side faces of the cells.

According to one embodiment, the turbulators and/or rib(s) project from the wall of one large side face of a cell and extend toward the wall of the large side face of another adjacent cell.

According to one embodiment, a thermal switch thermally insulates the turbulators and/or rib(s) from the wall of the large side face of the other adjacent cell.

According to one embodiment, the turbulators are made of a thermally insulating material, preferably made of a polymer material or a polymer-based composite material.

According to one embodiment, the turbulators have:
a first part suitable for being in contact with a large side face of a cell,
a second part suitable for being in contact with a large side face of another adjacent cell,
a thermal switch to thermally insulate the first part from the second part.

According to one embodiment, the first part and the second part of the turbulators are made of a thermally conductive material, preferably made of a polymer material or a polymer-based composite material.

According to one embodiment, the thermal switch forms a support to which the first part and the second part are attached.

According to one embodiment, the thermal switch forms a physical interface between the first part and the second part, said switch being made of a material having a melting point below a threshold temperature, so that when the temperature of the first part and/or of the second part reaches said threshold temperature, said switch melts without leaving any physical contact between said first part and said second part, which melting point is preferably less than or equal to 200° C.

According to one embodiment, the system comprises variable turbulator densities along the forced-circulation circuit, the turbulator density at the outlet of the forced-circulation circuit preferably being greater than the turbulator density at the inlet of said circuit.

According to one embodiment, the forced-circulation circuit comprises fluid circulation sections of variable width, preferably of decreasing width, gradually or continuously, from the inlet to the outlet.

According to one embodiment, the spacer and/or turbulators are snap-fastened or bonded to at least one cell.

According to one embodiment, the ribs are arranged so that the forced-circulation circuit has at least one change of direction of the fluid.

Yet another aspect of the invention relates to a cooling facility comprising a system according to one of the preceding features, and also comprising:
a battery pack comprising N adjacent battery cells, including two end cells each arranged at one end wall of the housing, N being an integer greater than 3,
the system comprises at least N−1 spacers, preferably N+1 spacers.

According to one embodiment:
one spacer is installed between each cell that is adjacent to another cell;
one spacer is installed between each end wall of the housing and the end cell, a large side face of which is adjacent to said wall,
the spacers are in accordance with one of the preceding features, such that all the large side faces of the cells are cooled by a forced-circulation circuit.

According to one embodiment:
the battery pack comprises two or more rows of cells placed side by side,
the ribs of each spacer are formed so as to create one or more forced-circulation circuits, each said circuit having one or more arched links on the two large side faces of two cells arranged side by side,
each spacer preferably comprises a median rib which extends over the height of said cells and which, during use, lies between side edges of said large side faces such that said median rib fills the space between the two cells and forms a seal between said cells.

According to one embodiment, openings are provided in the median rib so as to allow the circulation of fluid between the large side faces of two cells arranged side by side.

### BRIEF DESCRIPTION OF THE FIGURES

Further advantages and features of the invention will become better apparent from reading the following description of embodiments, given with reference to the attached drawings, produced by way of nonlimiting indicative examples and in which:

FIG. 1 is an exploded view showing various constituent elements of the device, system and facility according to the invention.

FIG. 2 is a perspective view of a housing.

FIG. 3 is a perspective view of an example of a spacer in accordance with the invention (the turbulators not being shown).

FIG. 4 shows an assembly of two adjacent battery cells on which spacers are installed (the turbulators not being shown).

FIG. 5 illustrates a view in cross section on A-A of the assembly of FIG. 4.

FIG. 6 illustrates a view in cross section on B-B of FIG. 2 (the beams and turbulators not being shown).

FIG. 7A, FIG. 7B, FIG. 7C, FIG. 7D, FIG. 7E and FIG. 7F illustrate various possible configurations of spacers and of fluid circulation (the turbulators not being shown).

FIG. 8A and FIG. 8B illustrate one way of circulating the fluid in the housing, said housing being viewed from above and from beneath, respectively.

FIG. 9 shows a configuration of the spacer with the turbulators.

FIG. 10 and FIG. 11 show different turbulator configurations.

FIG. 12, FIG. 13, FIG. 14, FIG. 15 and FIG. 16 are enlargements of detail D in FIG. 5 showing different turbulator arrangements.

FIG. 17 is a front view of a cell incorporating ribs and turbulators on one of its large side faces.

FIG. 18, FIG. 19, FIG. 20 and FIG. 21 show other turbulator arrangements.

FIG. 22 shows a battery pack comprising two rows of cells placed side by side (the turbulators not being shown).

FIG. 23 shows a possible configuration of a spacer for the battery pack of FIG. 22 (the turbulators not being shown).

FIG. 24 shows a possible configuration of fluid inlet and outlet manifolds.

### DESCRIPTION OF THE EMBODIMENTS

As used here, and unless indicated to the contrary, any use of the ordinal adjectives “first”, “second”, etc. when describing an object simply indicates that various occurrences of similar objects are mentioned and does not imply that the objects so described need to be in a given sequence, whether in time, in space, in ranking or in any other way. “X and/or Y” means: X alone or Y alone or X+Y. In general, it will be appreciated that, in the various attached figures, the objects have been drawn arbitrarily to make the drawings easier to read.

The thermal regulation system that forms the subject of the invention seeks to regulate the temperature of a battery pack, notably of a battery pack of an electric and/or hybrid motor vehicle. However, it may be fitted to other types of vehicles, or used to regulate the temperature of other electrical and/or electronic components such as power electronics elements, for example, and in a nonlimiting manner, semiconductors, such as diodes or transistors. These could also be components of computer servers. According to one preferred embodiment, the thermal regulation consists in cooling the cells of the battery pack.

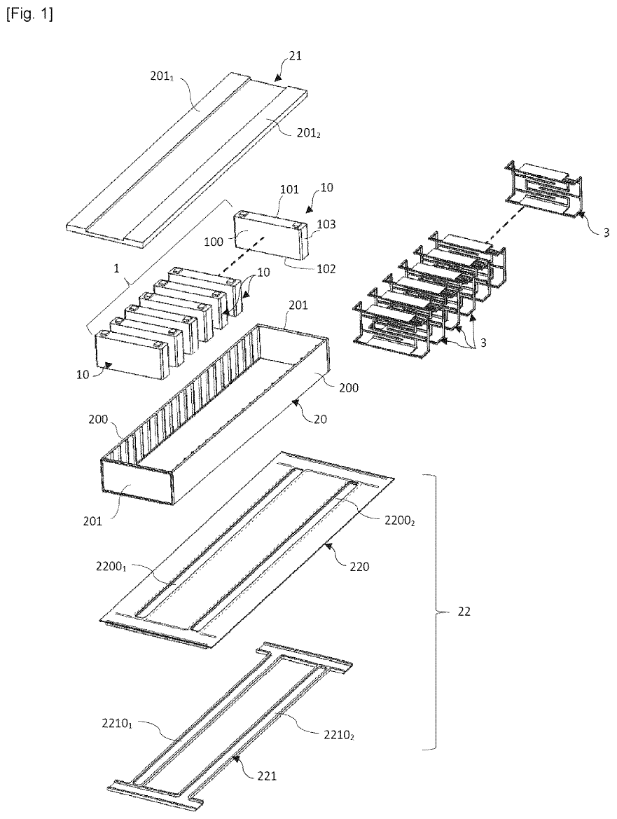

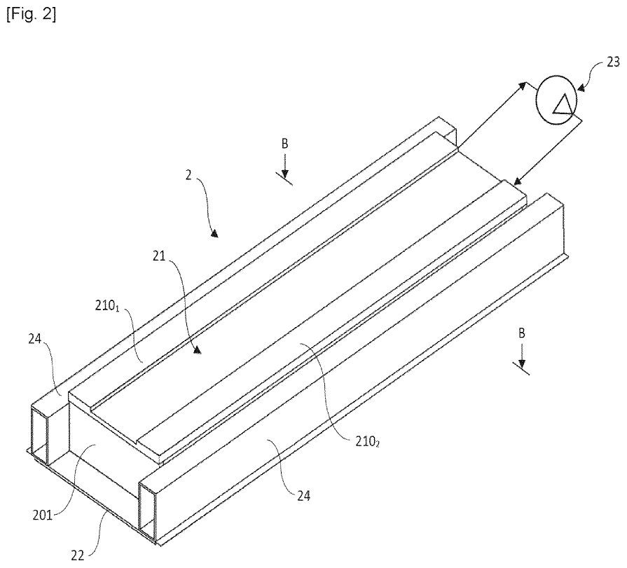

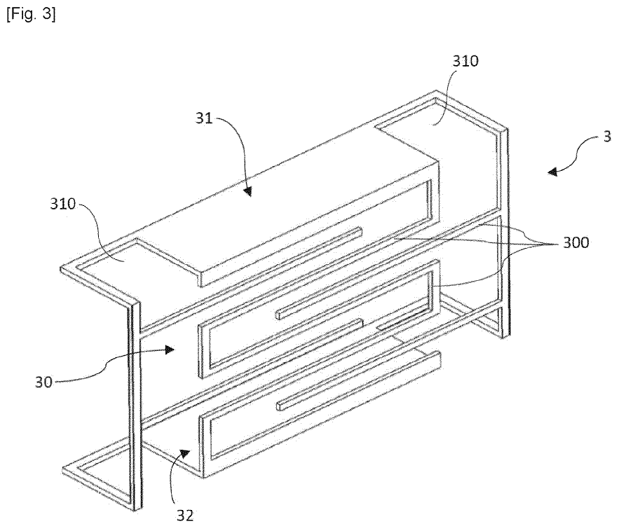

In FIG. 1, the battery pack 1 comprises at least two battery cells 10 and generally between 2 and 25 cells, said pack being housed in a housing 2 (FIG. 2). According to one embodiment, the battery pack 1 comprises N adjacent cells 10, where N is an integer greater than 2 and preferentially greater than 3, including two end cells positioned each at one end wall 201 of the housing 2.

The cells 10 are of the type known to those skilled in the art, generally prismatic, that is to say of parallelepipedal overall shape each having two large side faces 100, two small side faces 103, a top face 101 and a bottom face 102. These various faces are generally planar but some of them may be curved (dished or bowed). The cells 10 are positioned so they are adjacent at their large side faces 100.

The battery pack 1 is housed in a housing 2 formed by an enclosure 20 which is hermetically closed by a cover 21 and a bottom wall 22. The enclosure 20 has an internal space able to accommodate one or more battery packs. Structural beams 24 may be fixed to the enclosure 20 in order to stiffen the housing 2 further.

In FIG. 2, the housing 2 is of parallelepipedal overall shape, but other suitable shapes may be envisioned, notably according to the overall shape of the battery pack 2. According to one embodiment, the various elements 20, 21, 22 are produced by molding a plastic material, but other materials that suit those skilled in the art may be used.

In the example of FIG. 1, the enclosure 20 is bounded by two side walls 200 extending in a longitudinal direction, and two end walls 201 which are perpendicular to said side walls.

According to one embodiment, the cover 21 is provided with one or more heat-transfer fluid circulation channels 210₁, 210₂ forming manifolds, in fluidic communication with the enclosure 20. Preferentially, these channels 210₁, 210₂ extend along the entire length of the enclosure 20 so as to be in fluidic communication with all of the cells 10 of the pack 1. These channels 210₁, 210₂ may act as inlets (namely where the fluid arrives at the housing 2) or outlets (namely where the fluid is discharged from the housing 2). According to one embodiment, one channel 210₁ may act as an inlet, and another channel 210₂ may act as an outlet. According to another embodiment, the channels 210₁, 210₂ act as inlets. According to yet another embodiment, the channels 210₁, 210₂ act as outlets. In another embodiment, the cover 21 has no heat-transfer fluid-circulation channel, the fluid being inlet/outlet exclusively at the bottom wall 22.

According to one embodiment, the base wall 22 is made of two parts 220, 221 assembled together, for example by screwing, welding, bonding, etc. A first part 22 is in the form of a plate intended to be attached at the bottom of the enclosure 20. A second part 221 exhibits profile sections in the form of channels 2210₁, 2210₂ opening at openings 2200₁, 2200₂ formed in the plate 222, which openings are in fluidic communication with the enclosure 20. In FIG. 1, these openings extend along the entire length of the enclosure 20 so as to be in fluidic communication with all of the cells 10 of the pack 1. The channels 2210₁, 2210₂ thus open onto each spacer 3 (into each inter-cell space). The bottom wall 22 may, however, be made as a single piece, the channels 2210 then being directly integrated into the plate 220, for example by molding. The bottom wall 22 may form the bottom of the enclosure 20 or may be an attached additional wall independent of the bottom of said enclosure.

The channels 2210₁, 2210₂ in the bottom wall 22 are used for the circulation of the heat-transfer fluid 210. They may act as inlets (namely where the fluid arrives at the housing 2) or outlets (namely where the fluid is discharged from the housing 2). According to one embodiment, one channel 2210₁ may act as an inlet, and another channel 2210₂ may act as an outlet. According to another embodiment, the channels 2210₁, 2210₂ act as inlets. According to yet another embodiment, the channels 2210₁, 2210₂ act as outlets. In another embodiment, the bottom wall 22 has no heat-transfer fluid-circulation channel, the fluid being inlet/outlet exclusively at the cover 21.

With reference to FIG. 2, the inlets/outlets of the housing 2 are connected to a heat-transfer fluid circulation circuit 23 comprising, for example, a pumping circuit, notably enabling the heat-transfer fluid to be circulated in said housing in order to regulate the temperature of the cells 10 which are housed therein. The circulation of the fluid in the housing 2 is described in detail later on in the description. Temperature control preferentially consists of regulated cooling to maintain the cells 10 at a temperature less than or equal to a threshold temperature, for example between 20° C. and 40° C. When the cells 10 exceed this threshold temperature, they are cooled by the heat transfer fluid, which is then a cooling fluid.

In a particularly advantageous manner, the inlet of the housing 2 may comprise a sieve configured to filter the heat-transfer fluid so as to prevent the circulation of particles in said housing. These particles also have the drawback of reducing the efficiency of the heat-transfer fluid, notably in its heat exchange capacity. The sieve is thus preferentially placed at the inlet to the housing 2 and/or upstream of the fluid inlet to circuit 23. For example, the sieve is installed at the inlet to channels 210₁, 210₂, 2210₁, 2210₂. Advantageously, the sieve may be generally cylindrical in shape. Alternatively, the sieve is suitable for the shape of the channels/manifolds 210₁, 210₂, 2210₁, 2210₂. The sieve is generally formed from a rigid structure, notably manufactured from a plastic or metallic material, in the form of a net or frame. This net serves as a support for a mesh grid that is capable of enabling the filtration of particles less than 200 μm in size, preferentially less than 50 μm in size. The mesh grid is advantageously made of a metallic material.

In certain cases, for example when the vehicle is started, regulation may also consist in heating the cells 10, notably when they are at a temperature less than or equal to a threshold temperature, for example less than 0° C. Below this threshold temperature, the cells 10 are heated by the heat-transfer fluid, which is then a heating fluid.

The heat-transfer fluid used is preferably a dielectric liquid, for example a mineral oil or fluorinated liquid. The heat-transfer fluid may, however, be in some other form, for example the form of blown air. The fluid may be precooled or preheated according to the thermal regulation intended.

A spacer 3 (or insert, the two terms being synonymous within the meaning of the invention) is installed between each cell 10 that is adjacent to another cell, so as to space these cells apart. A spacer 3 is also advantageously installed between each end wall 201 of the housing 2 and the end cell 10, a large side face 100 of which is adjacent to said wall. According to one embodiment, if the battery pack 1 comprises N cells 10, the system comprises at least N−1 spacers 3, preferably N+1 spacers.

Advantageously, the spacers 3 have a relatively low thermal conductivity so as to act as a thermal insulator between the cells. According to one embodiment, the spacers 3 are made from a material having a thermal conductivity of at most 0.4 W. m⁻¹ .K⁻¹, preferably a thermal conductivity of at most 0.2 W. m⁻¹ .K⁻¹. The material used may be a polymer or polymer-based composite material, or a material from the silicate family, preferably being made of fiber-reinforced calcium silicate.

Each spacer 3 has a structure configured so that it can be installed removably on a cell 10, preferentially by snap-fastening. According to one embodiment, the structure of the spacer 3 is adjusted (for example by elastically deforming said structure) to suit the shape of the cell 10 so that it can be mounted tightly on said cell so that the contacts between said structure and said cell are contacts that are fluidtight. According to another embodiment, the spacers 3 may be permanently installed on the cells 10, and for example attached by bonding or welding.

In FIGS. 3, 4 and 5, the structure of the spacer 3 has the general shape of a U-shaped channel. It may be in the form of a single-piece component or in the form of several parts that are different from each other. The spacer 3 has a first bearing zone 30 configured to come to bear against a large side face 100 of the cell 10, a second bearing zone 31 configured to come to bear against the top face 101 of said cell, and a third bearing zone 32 configured to come to bear against the bottom face 102 of said cell. The structure of the spacer 3 may, however, have a different configuration, and for example have only the first bearing zone 30, or only the first zone 30 and the second zone 31, or only the first zone 30 and the third zone 32.

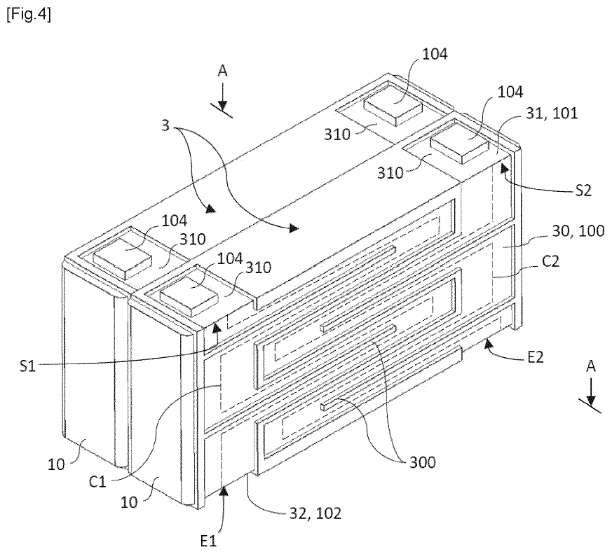

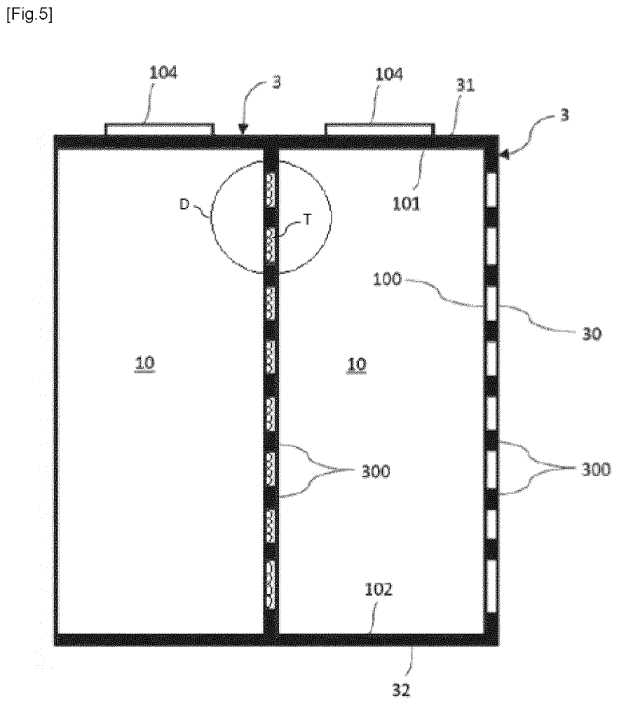

As illustrated in FIGS. 4 and 5, when the cells 10 are installed in the housing 2 in the configuration of use, the first zone 30 comes to bear not only against the large side face 100 of the cell 10 against which the space 3 is installed (hereinafter referred to as the “front” large side face) but also against the large side face 100 of the adjacent cell 10 (hereinafter referred to as the “rear” large side face). The first zone 30 is thus sandwiched between the adjacent large side faces of the cells. According to a preferred embodiment, the contacts between the first zone 30 and the front and rear large side faces of the adjacent cells are contacts that are fluidtight. Alternatively or in addition, one or more sealing gaskets are installed in the space between the adjacent cells 10 so as to create contacts that are fluidtight.

The first zone 30 has the same dimensions, or substantially the same dimensions, in terms of length and width, as those of a large side face 100. It defines a flow zone located opposite the large side face 100 of the cell 10 against which the spacer 3 is installed and which extends over the majority of said large side face. Symmetrically, this flow zone is also located opposite the rear large side face of the adjacent cell, so that the fluid flowing in said zone is in contact with the two large side faces of the adjacent cells.

According to one embodiment, the flow zone 30 extends over at least 51%, advantageously at least 90% and preferentially at least 95% of the surface of the adjacent large side faces 100. The majority of these large side faces 100 can thus be in contact with the heat-transfer fluid, as explained later in the description.

One or more ribs 300 extend in the perforated part of the flow zone 30 and are arranged so as to form one or more forced-circulation circuits for the circulation of the heat-transfer fluid between the adjacent cells. The term “forced circulation” means that the fluid is forced to follow one or more individual paths imposed by the arrangement of the rib or ribs 300. This or these circuits are thus bounded on the one hand by the adjacent large side faces 100 of the cells and on the other hand by the ribs 300. All the large side faces 100 of the cells 10 are thus cooled by a forced-circulation circuit. The number of passes (which is to say direction changes in a forced-circulation circuit) is tailored to suit the desired level of heat exchange and/or to suit the permissible pressure drop. The best results in terms of heat exchange are obtained when the forced-circulation circuit has at least one change of direction of the fluid, advantageously at least three and preferentially between five and ten changes of direction (this range offers a good compromise in terms of heat exchange and loss of pressure).

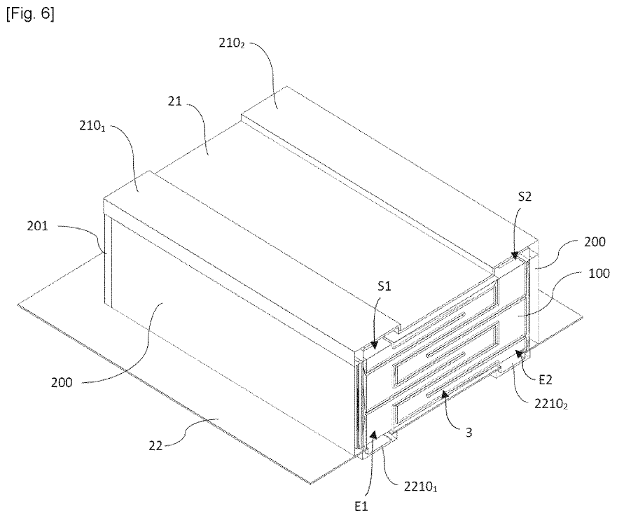

Each forced-circulation circuit comprises a fluid inlet and a fluid outlet, which inlet/outlet are defined by the arrangement of the rib or ribs 300. In the exemplary embodiment of FIGS. 4 and 6, several ribs 300 are arranged in such a way as to form two distinct circuits, C1, C2 respectively, each circuit comprising a respective inlet E1 and E2 and a respective outlet S1 and S2. In other embodiments, the ribs 300 are arranged to form M forced-circulation circuits, where M is an integer greater than 2.

In the example of FIG. 4, the inlets E1, E2 are situated at one edge of a large side face 100 (at the junction where said large side face meets the bottom face 102) and the outlets S1, S2 are situated at another edge of said large face (at the junction where said large face meets the top face 101). Other inlet/outlet configurations are, however, conceivable, notably a configuration that is the inverse of that of FIG. 4. Likewise, the inlets and, respectively, the outlets, are not necessarily situated at the one same edge of the large side face 100. An inlet E1 of a first circuit C1 may be situated at a first edge (for example a top edge) and the outlet S1 at a second edge (for example a bottom edge), whereas the inlet E2 of a second circuit C2 is situated at said second edge and the outlet S2 at said first edge, or vice versa. According to another configuration example, the inlet E1 and the outlet E2 of a first circuit C1 are situated at the one same edge, for example a bottom edge, whereas the inlet E2 and the outlet E2 of a second circuit C2 are situated at another, for example a top edge. In other embodiments, all or some of the inlets/outlets are situated at one or more of the side edges of a large side face 100 (at the junction where said large side face meets a small side face 103).

The ribs 300 are preferably straight, but may be curved or have curved portions and rectilinear portions, or may be in the form of broken lines, or any other form that suits the person skilled in the art.

The ribs 300 are in close contact with the adjacent large side faces 100. This close contact creates fluidtightness such that the circulation of the fluid in a forced-circulation circuit C1, C2 takes place only between the inlet E1, E2 and the outlet S1, S2 of said circuit. When a plurality of circuits are defined by the spacer 3, there is notably no fluidic communication between these circuits, thus ensuring uniform circulation within each circuit. Alternatively or in addition, one or more sealing gaskets are arranged in the space between the adjacent cells 10, notably on the ribs 300, such that the circulation of the fluid in a forced-circulation circuit takes place only between the inlet and the outlet of said circuit.

The thickness of the structure of the spacer 3 and/or the thickness of the ribs 300 is/are dependent on the desired distancing between the cells 10 and/or the desired flow rate for the fluid circulating in the circuit or circuits. The best results, notably in terms of regulation, are obtained when this thickness is comprised between 0.5 mm and 5 mm, advantageously between 1 mm and 4 mm, and preferentially between 1.5 mm and 3.5 mm.

In addition to distancing the adjacent cells 10 so that the heat-transfer fluid can flow, the spacers 3 also assume a mechanical role preventing the cells 10 from swelling as a result of their increase in temperature. This is because they are able to keep the cells 10 in compression under the effect of this swelling, thereby ensuring that the cells can work to their full capacity.

In order for the ribs 300 to block off at least the surface of the large side faces 100 that is in contact with the heat-transfer fluid, said ribs occupy at most 10%, advantageously at most 5%, of the surface of a large side face 100. Optimum results in terms of limiting of the swelling and the efficiency of the heat exchanges are obtained when the ribs 300 have a width comprised between 0.5 mm and 5 mm, advantageously between 1 mm and 4 mm, and preferentially between 1.5 mm and 3.5 mm. The ribs 300 may have the same width or different widths. In particular, the ribs 300 or rib portions situated in the central zone of the large side faces 100 may be wider insofar as the mechanical stresses due to the swelling are at their maximum in this zone.

In the attached figures, the second zone 31 and the third zone 32 have the same dimensions, or substantially the same dimensions, in terms of length and width, as those of the top face 101 and bottom face 102 of a cell 10. However, they could have different dimensions in terms of length and/or width. The second zone 31 advantageously has perforated parts 310 designed to leave the connection terminals 104 of the cell 10 free. The third zone 32 may also have perforated parts. In these perforated parts, the fluid is in contact with the top face 101 and lower face 102, contributing to the heat exchanges and to the thermal regulation of the cell 10 at said faces.

When the cells 10 and the spacers 3 are installed in the housing 2 in the configuration of use, the inlet(s)/outlet(s) of the circuit(s) C1, C2 are in fluidic communication with the inlet(s)/outlet(s) of the circuit 23 of the housing 2. In FIG. 6, the openings 2210₁, 2210₂ in the bottom wall 22 open onto the inlets E1, E2 and the channels 210₁, 210₂ of the cover 21 open onto the outlets S1, S2. Thus, the channels 210₁, 210₂ and 2210₁, 2210₂ open onto each spacer 3, that is to say into each inter-cell space.

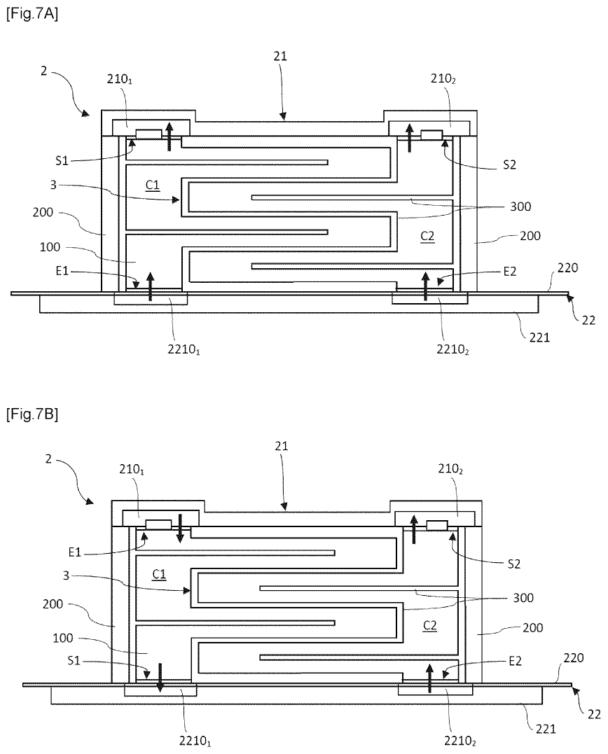

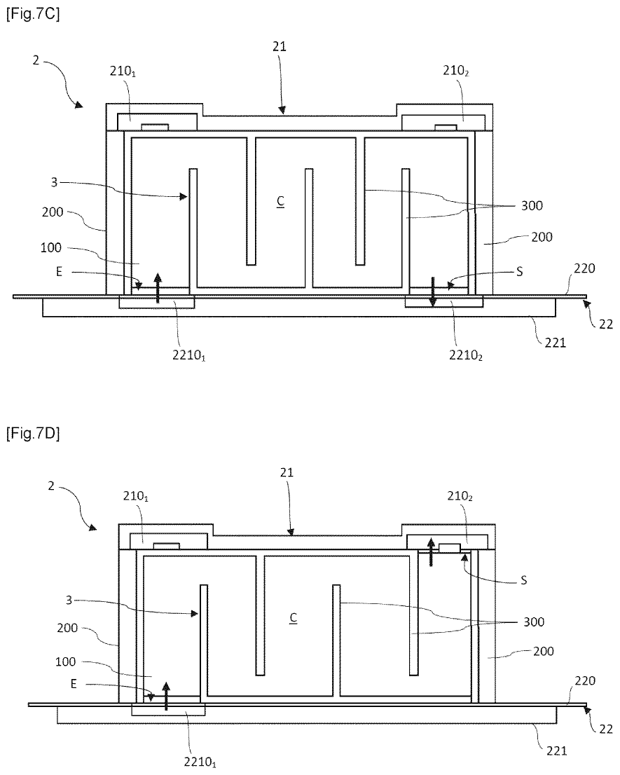

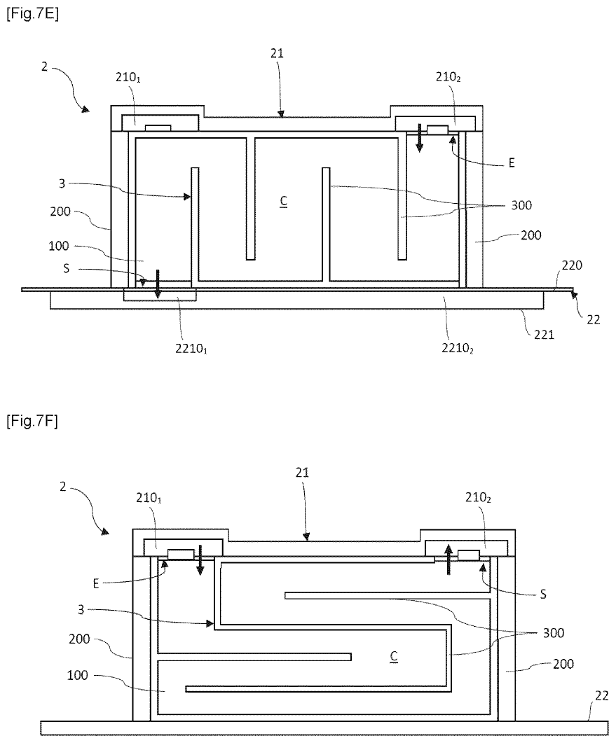

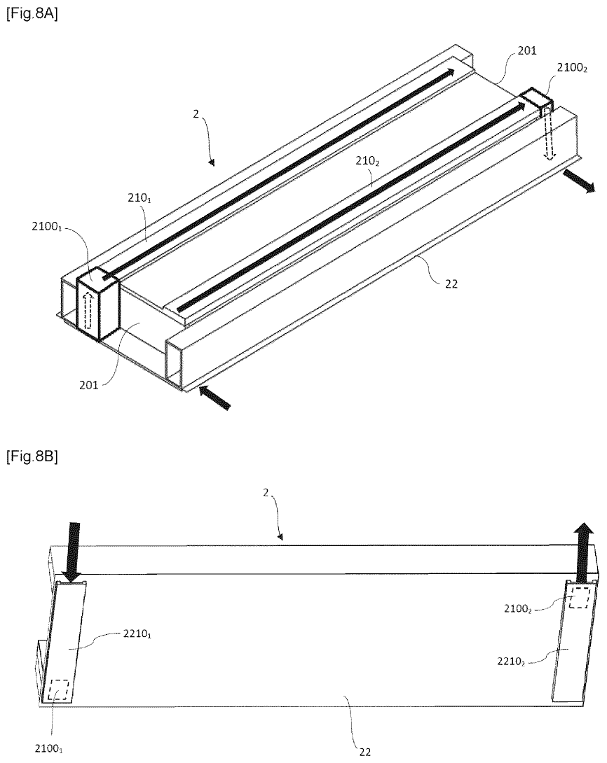

FIGS. 7A, 7B, 7C, 7D, 7E and 7F illustrate various configurations of the device. FIG. 7A corresponds to the abovementioned configuration. The spacer 3 comprises several ribs 300 arranged in such a way as to form a first forced-circulation circuit C1 and a second forced-circulation circuit C2. The first circuit C1 comprises an inlet E1 and an outlet S1 and the second circuit C2 comprises an inlet E2 and an outlet S2. The inlets E1 and E2 are situated at the bottom edge of the large side face 100 and the outlets S1, S2 at the top edge of said large face. The inlets E1 and E2 are in fluidic communication with the inlet channels 2210₁, 2210₂ formed in the bottom wall 2. The outlets S1 and S2 are in fluidic communication with the discharge channels 210₁, 210₂ formed in the cover 21. The fluid enters via the inlet channel 2210₁, is forcibly circulated in the first circuit C1 from the inlet E1 as far as the outlet S1, and is discharged via the discharge channel 210₁. In parallel, the fluid also enters via the other inlet channel 2210₂, is forcibly circulated in the second circuit C2 from the inlet E2 as far as the outlet S2, and is discharged via the discharge channel 210₂. In this instance, the circulation of the fluid in the first circuit C1 and the circulation of said fluid in the second circuit C2 are in the same direction.

The configuration of FIG. 7B is similar to that of FIG. 7A. The main difference is that the inlets E1 and E2 are not situated at the same edge of the large side face 100, and neither are the outlets S1, S2.

In the configuration of FIG. 7C, the ribs 300 are arranged in such a way as to form a single forced-circulation circuit C comprising an inlet E and an outlet S which are both situated at the bottom edge of the large side face 100.

The configuration of FIG. 7D is similar to that of FIG. 7C. The main difference is that the inlet E is situated at the bottom edge of the large face 100 whereas the outlet S is situated at the top edge of said large face.

A configuration that is the inverse of FIG. 7D may be envisioned, as illustrated in FIG. 7E. In that instance, it is conceivable that the inlet E is situated at the top edge of the large face 100 and the outlet S is situated at the bottom edge of said large face.

In the configuration of FIG. 7F, the inlet E and the outlet S of the circuit C are situated at the top edge of the large side face 100. The fluid in this instance enters and leaves via the cover 21, said fluid not circulating through the bottom wall 22.

FIGS. 8A and 8B illustrate yet another configuration of the device that can render the assembly particularly compact and easy to install. The configuration of the spacer 3 is similar to that of FIG. 7F. However, the fluid enters and leaves via the bottom wall 22. This wall is provided with an inlet channel 2210₁ and with a discharge channel 2210₂, each of which opens onto each spacer 3 (into each inter-cell space). The fluidic connection between the housing 2 and the circuit 23 is therefore solely at the bottom wall 22, thereby simplifying the installation. Furthermore, because the cover 21 has no connections to the circuit 23, it can be removed quickly and easily if the battery pack 1 requires intervention.

A first duct 21001 conveys the fluid circulating in the inlet channel 2210₁ as far as a first channel 210₁ formed in the cover 21. According to one embodiment, the ends of the first duct 21001 open respectively into the inlet channel 2210₁ and into the first channel 210₁. The first duct 21001 thus allows the fluid to be “raised” from the bottom wall 22 as far as the cover 21. The first channel 210₁ formed in the cover 21 allows the inlets E of the various circuits C to be supplied in parallel. In FIG. 8A, the first duct 2100₁ is formed at an end wall 201 of the housing 2.

A second duct 2100₂ allows the fluid circulating in the second channel 210₂ formed in the cover 21 to be conveyed to the discharge channel 2210₂. According to one embodiment, the ends of the second duct 2100₂ open respectively into the second channel 210₂ and into the discharge channel 2210₂. The second duct 2100₂ thus allows the fluid to be “lowered” from the cover 21 as far as the bottom wall 22. The second channel 210₂ formed in the cover 21 is in fluidic communication with the outlets S of the various circuits C. In FIG. 8A, the second duct 2100₂ is formed at another end wall 201 of the housing 2.

In this configuration, the fluid enters via the inlet channel 2210₁ and passes through the first duct 2100₁ in order to reach the first channel 210₁ of the cover 21. The fluid is therefore forcibly circulated in the circuit C from the inlet E as far as the outlet S. The fluid next circulates in the second channel 210₂ and passes along the second duct 2100₂ to reach the discharge channel 2210₂ by means of which it is discharged.

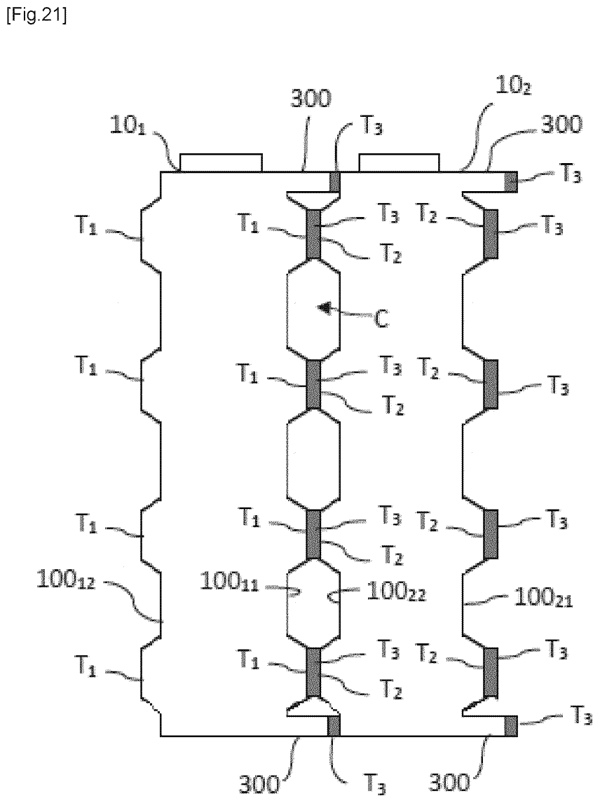

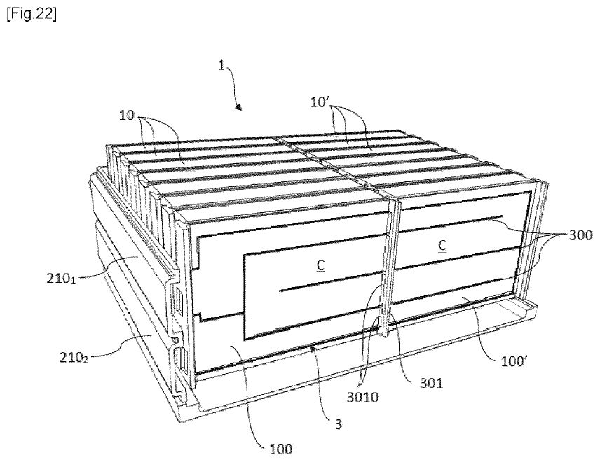

According to one embodiment, the battery pack 1 has two or more rows of cells placed side by side. In FIG. 22, the battery pack 1 is, for example, composed of two rows of cells 10, 10′ placed side by side.

To allow the cells 10, 10′ to be held in place and to allow homogeneous flow along their large lateral faces 100, 100′, the ribs 300 of the spacer 3 are formed so as to create one or more forced-circulation circuits C, each having one or more passes, as in the case of a spacer for a single cell described previously.

Advantageously, to ensure that the temperature is as uniform as possible, each circuit C (and each of its passes) extends over—or straddles—the two large side faces 100, 100′ of the cells 10, 10′ arranged side by side.

The spacer 3 forms a fluid-tight seal along the entire length of circuit C, as with a single-cell spacer described previously.

In FIGS. 22, 23 and 24, the spacer 3 comprises a median rib 301 which extends across the height of the cells 10, 10′ and which, in use, is installed between the side edges of the large side faces 100, 100′. This median rib 301 thus fills the space between the two cells 10, 10′ and forms a seal between said cells. Apertures 3010 are provided in the median rib 301 so as to allow fluid to circulate between the large side faces 100, 100′.

The median rib 301 also allows the cells 10, 10′ arranged side by side to be spaced apart and plays a mechanical role in preventing the swelling of said cells induced by their rise in temperature. It helps to keep the cells 10, 10′ further in compression under the effect of this swelling, which ensures a maximum capacity of said cells.

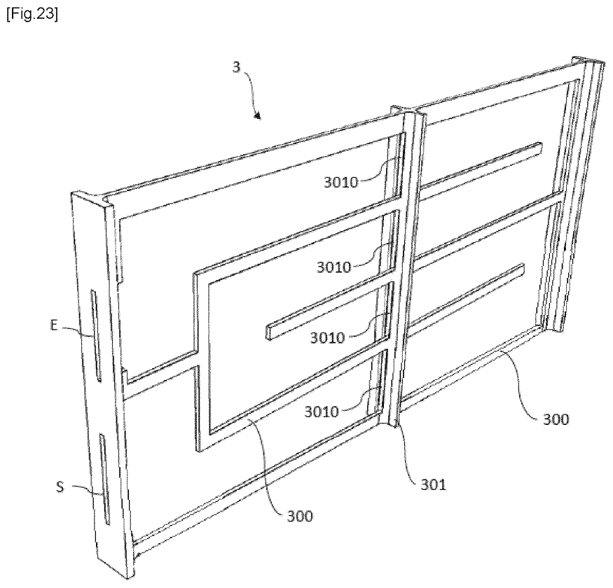

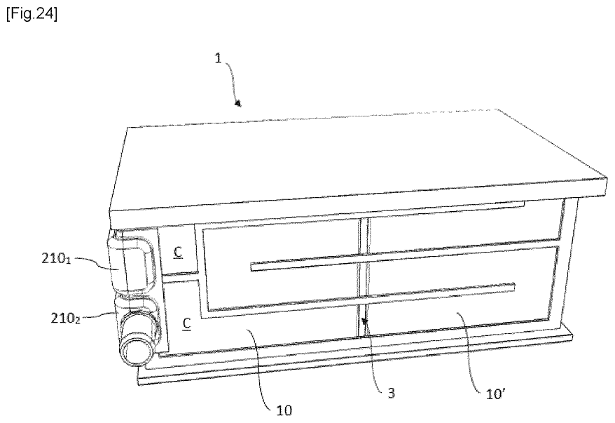

Sealing between the cells 10, 10′ is particularly advantageous when the fluid inlet/outlet manifolds 210₁, 210₂ are arranged laterally and on one side only of the battery pack 1, as illustrated in FIGS. 22 and 24. The inlet E and outlet S (FIG. 23) of circuit C are thus arranged in the spacer 3, at a rib located at the edge of the cell.

If the manifolds are positioned on either side of the cells 10, 10′ (for example the inlet manifold positioned on one side of cell 10 and the outlet manifold positioned on the opposite side of cell 10′), this sealing would not necessarily be important. Specifically, the space between the cells 10, 10′ may be used as an intermediate manifold facilitating the distribution of the fluid between the cells. In this case, the spacer 3 may not include a median rib 301 or may include a median rib, but which does not fill the space between the two cells 10, 10′.

According to another embodiment, the ribs 300 may be arranged so as to form a first circuit which winds along the large side face 100 of the first cell 10 and a second circuit which winds along the large side face 100′ of the second cell 10′. Communication between the two circuits may be effected at the cover 21 (more particularly at the busbar zone) or at the bottom wall 22 of the housing 2. This embodiment has the advantage of not requiring sealing between the cells 10, 10′, but is not optimal in terms of temperature homogeneity due to the fact that the fluid arrives hotter on the second cell 10′ than on the first cell 10.

In FIG. 24, the inlet/outlet manifolds 210₁, 210₂ are arranged laterally and on one side only of the battery pack 1. To provide a supply to one or more cells 10 located at the ends of the battery pack 1, the inlet manifold 210₁ and/or the outlet manifold 210₂ may be extended and angled so as to open directly into the circuit C formed at at least one of said end cells.

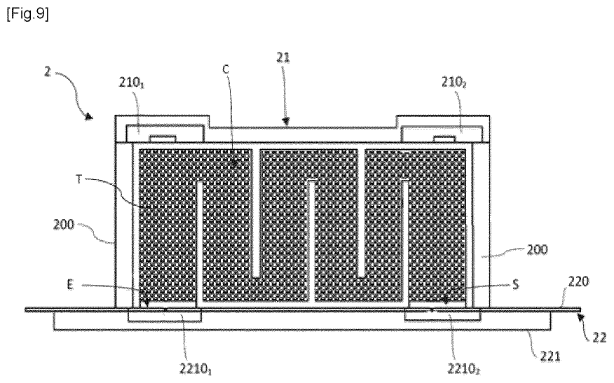

According to a feature of the invention illustrated in FIG. 9, turbulators T (or disturbance elements, the two terms being synonymous for the purposes of the invention) are present in the flow zone 30, along the circuit(s) C, C1, C2 described previously, so as to create turbulence in the flow of the heat-transfer fluid between the inlet and the outlet of said circuit(s). The turbulence thus created allows improved heat exchange between the fluid and the cells, notably by increasing the heat exchange (or transmission) coefficient. Specifically, by disrupting the flow, the turbulators break up the boundary layer and thereby increase the exchange coefficient.

For the sake of brevity and clarity, the following description describes turbulators arranged in a single forced-circulation circuit C. However, the present invention also covers spacers having several forced-circulation circuits, and in which the turbulators are arranged in all or some of these circuits.

According to a preferred embodiment, the turbulators T are present all along the circuit C, from the inlet E to the outlet S, so as to maximize heat exchange with the large side faces 100. According to another embodiment, the turbulators T are present only on one or more portions of the circuit C, and notably located in the zones of the large side faces 100 where the temperatures are highest (in the case where it is sought to cool the cells) and/or lowest (in the case where it is sought to heat the cells).

Depending on the surface area of the exchange zone in circuit C, the number of turbulators T may range from about ten to several hundred, or even several thousand. For example, one or more dozen turbulators per cm² may be provided. They may be spread in a regular manner, i.e. with the same density along circuit C, or distributed irregularly, i.e. with variable densities along said circuit.

Variable densities of turbulators T allow the heat exchanges along circuit C to be homogenized, notably when the turbulator density at outlet S is greater than the turbulator density at inlet E. Specifically, the heat flow P may be written according to the following formula: P=K.Se.ΔT; in which K is the heat exchange coefficient, Se the exchange surface area and ΔT represents the temperature difference between the fluid and the large side face 100 over which said fluid flows. Assuming that the exchange surface area is constant, that the temperature of the large side face 100 is substantially the same at the inlet E and the outlet S, but that the temperature of the fluid changes between the inlet E and the outlet S (due to heat exchanges along the circuit C), then ΔT_{inlet E}≠ΔT_{outlet S}. More particularly, ΔT decreases from inlet E to outlet S.

In order to obtain homogeneous heat exchange along circuit C, the aim is for P_{inlet E}=P_{outlet S}, and ideally for P to be constant along the fluid flow in circuit C. As the heat exchange coefficient K is proportional to the Reynolds number, increasing the density of the turbulators T will allow the value of the coefficient K to be increased. Thus, the reduction in ΔT along circuit C is offset by an increase in the coefficient K, so that equilibration may be obtained between P_{inlet E} and P_{outlet S}. Also, according to a preferred embodiment, the density of the turbulators T increases, gradually or continuously, from the inlet E to the outlet S of circuit C. In the case where the turbulators T are made of a thermally conductive material and participate in heat exchange, increasing the density of said turbulators increases the exchange surface area Se. The reduction in ΔT along the circuit C may thus also be compensated for by an increase in the exchange surface area Se.

Alternatively, the reduction in ΔT can be compensated for (without reducing the value of the coefficient K and thus without modifying the density of the turbulators), by increasing the exchange surface area Se by modifying the shape of said turbulators between the inlet E and the outlet S.

According to yet another embodiment, which may complement or replace the embodiments described previously, circuit C comprises fluid circulation sections of variable width so that the fluid flow speed varies from one section to another. This variability in speed allows the value of the coefficient K to be varied (without having to modify the density of the turbulators). Advantageously, these sections have a decreasing width, gradually or continuously, from the inlet E to the outlet S of circuit C, so that the speed increases from said inlet to said outlet. The best results in terms of heat flow homogeneity are obtained when the decreasing width of the sections from the inlet E to the outlet S is between −20% and −80%, preferably between −40% and −60%.

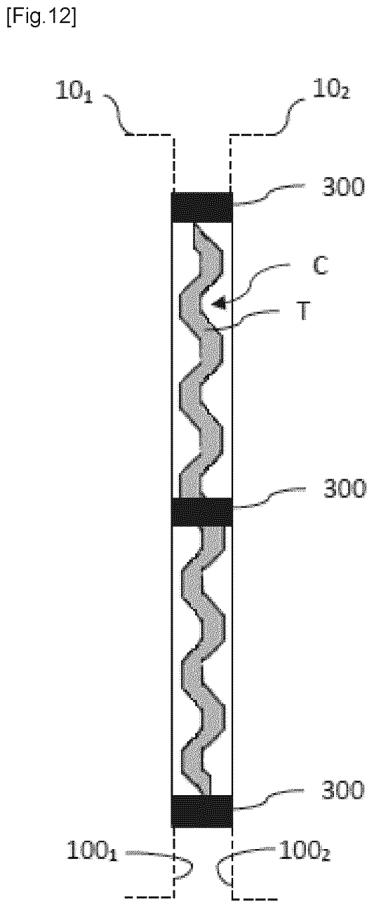

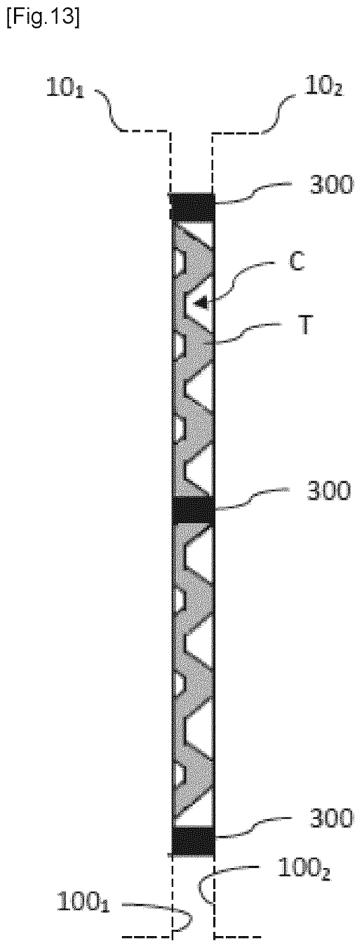

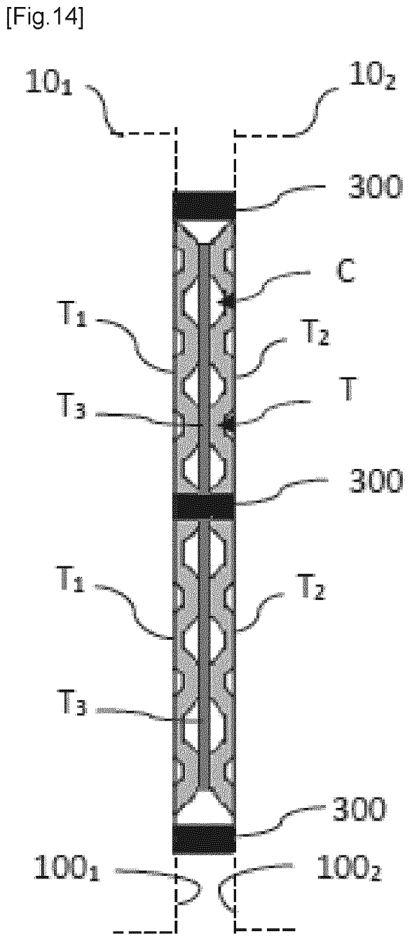

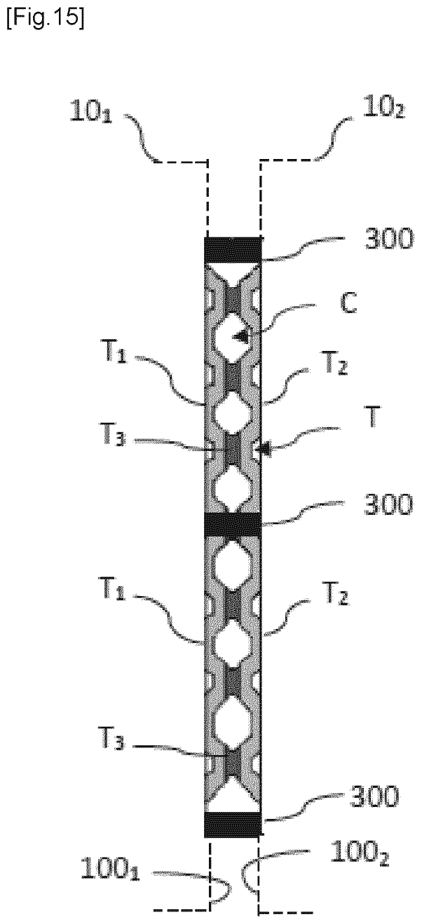

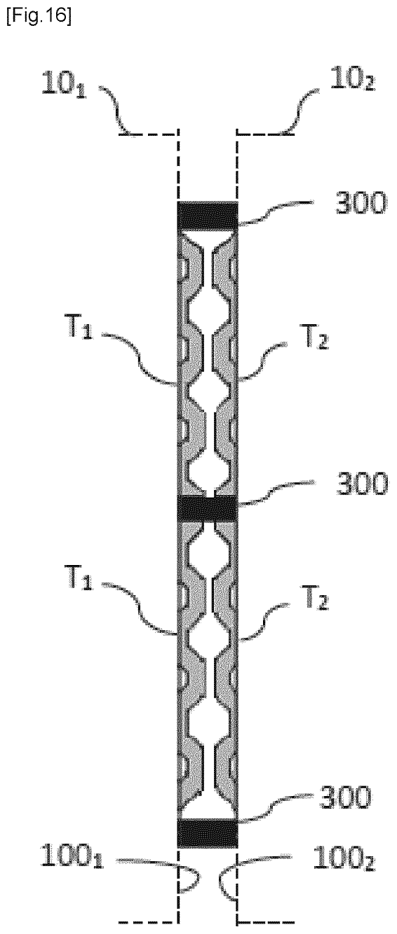

In FIGS. 9 to 21, the turbulators T are in relief and extend into the height of the ribs 300, or in other words into the space separating two adjacent cells 10a, 10b or into the thickness of the fluid blade. The height of the turbulators T is advantageously greater than or equal to 50% of that of the ribs 300, preferentially greater than 70%, and very preferentially greater than or equal to 90%. According to a preferred embodiment illustrated in FIG. 13, which allows turbulence to be optimized, the height of the turbulators T corresponds to that of the ribs 300 (and/or to the space separating two adjacent cells and/or to the thickness of the fluid blade) so that said turbulators are in contact with the two adjacent large side faces 100₁, 100₂ of the cells 10₁, 10₂.

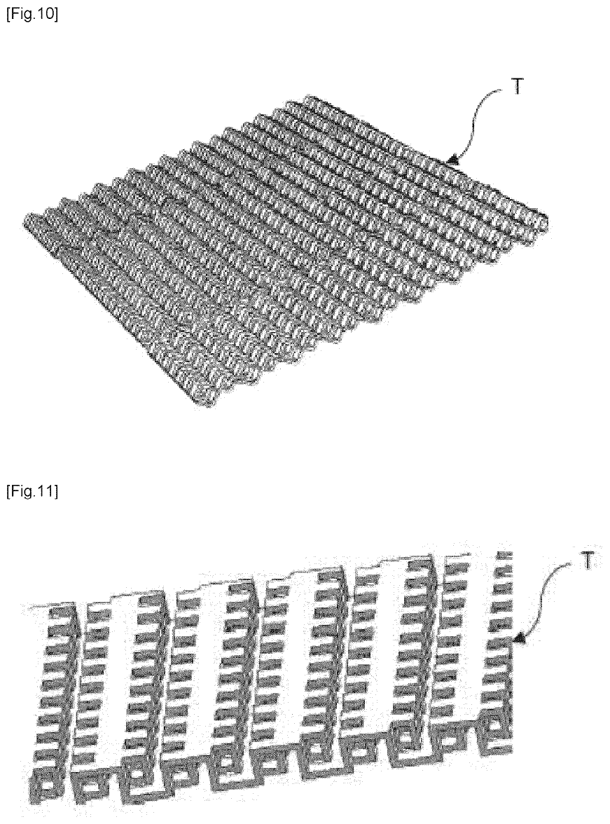

The turbulators T may have the shape of ribs, nipples, half-spheres, cylindrical or polygonal tubes, pyramids, fins, etc. In FIGS. 10 and 11, the turbulators T form a lattice or an alveolar (or pseudo-alveolar) structure having openings so that the fluid can flow along each of the adjacent large side faces 100₁, 100₂. This type of structure gives very good results in terms of heat exchange. The turbulators T may for example be obtained by molding, stamping, rolling, 3D printing, or via any other technique suitable to a person skilled in the art.

The turbulators T and/or the rib(s) 300 are arranged on one or more supports different from the spacer 3 and attached in the forced-circulation circuit C. The support(s) may then be held in position on the cells 10₁ and/or 10₂ by bonding, heat-welding, snap-fastening, interlocking, or by any other means suitable to a person skilled in the art.

In an embodiment variant which has the advantage of being simple, inexpensive, lightweight and easy to install, the turbulators T form a single-piece component with the spacer 3. The turbulators T and the rib(s) 300 may, for example, be formed by molding, stamping or die-cutting a sheet or strip.

In order to participate actively in heat exchange, the turbulators T may be made of a thermally conductive material and/or have a relatively high thermal conductivity, for example greater than 100 W.m⁻¹.K⁻¹, preferably greater than 200 W.m⁻¹.K⁻¹. The material used for the support may be aluminum or an aluminum alloy so as to obtain a good weight/price/thermal conductivity compromise. Other materials may be used, such as copper, copper alloy, zinc, zinc alloy, carbon, polymers charged with metal powders or flakes, etc.

According to one embodiment variant, the turbulators T are made from a heat-insulating material and/or a material which has a relatively low thermal conductivity, for example at most 0.4 W.m⁻¹.K⁻¹, preferably at most 0.2 W.m⁻¹.K⁻¹. The material used may be a different or preferentially identical material to that of the spacer 3, notably a polymer or polymer-based composite material, or a material from the silicate family, preferably fiber-reinforced calcium silicate. One advantage of using a heat-insulating material and/or a material which has a relatively low thermal conductivity is that, in the event of thermal runaway of a cell 101, the heat is not transferred—or is only sparingly transferred—to adjacent cells 102.

However, this design has the drawback of not taking advantage of the increase in exchange surface area offered by the turbulators T. Thus, in the solution illustrated by way of nonlimiting example in FIGS. 14 and 15, the turbulators T have a dual function: to disrupt the fluid flow so as to promote heat exchange and to increase the heat exchange surface area.

The turbulators T here have a first part T₁ suitable for being in contact with a large side face 100₁ of a cell 10₁, and a second part T₂ suitable for being in contact with a large side face 100₂ of an adjacent cell 10₂. These two parts T₁ and T₂ are made of a thermally conductive material and/or a material having a relatively high thermal conductivity of the type described previously.

The two parts T₁ and T₂ are thermally insulated by a thermal switch T₃, so that in the event of thermal runaway of a cell 10₁, the heat is not transferred—or is only sparingly transferred—to the adjacent cell 10₂ (or vice versa).

According to a preferred embodiment, the thermal switch T₃ is made of a heat-insulating material and/or has a relatively low thermal conductivity of the type described previously.

In FIG. 14, the switch T₃ is in the form of a support to which the parts T₁ and T₂ are attached, for example a plastic plate to which said parts are bonded.

In FIG. 15, the turbulators T are made of a composite material obtained, for example, via an injection or 3D printing technique, the two parts T₁ and T₂ being made of a thermally conductive material and/or a material having a relatively high thermal conductivity of the type described previously, and the switch T₃, forming the core, being made of a heat-insulating material and/or a material having a relatively low thermal conductivity of the type described previously.

According to one embodiment variant, the switch T₃ is made of a phase-change material having a melting point below a threshold temperature. This is notably a temperature characteristic of a thermal runaway of a cell 10, typically a temperature in excess of 200° C. In this example, the material of the switch T₃ is chosen so that its melting point is less than or equal to 200° C. Materials such as, but not limited to, acrylonitrile butadiene styrene (ABS), polyacetal copolymer or polyoxymethylene (POMC or POM), high-density polyethylene (HDPE), polypropylene (PP) and polyvinyl chloride (PVC) may notably be used.

Thus, when the temperature of the cell 10₁ (or, respectively, 10₂) reaches the threshold temperature, heat is also transmitted to the switch T₃ via the first part T₁ (or, respectively, the second part T₂). The temperature of the switch T₃ is then such that it melts without leaving any physical contact between the first part T₁ and said second part T₂ (FIG. 16). In this state, the heat emitted by the cell 10₁ cannot be transferred to the adjacent cell 10₂ (or vice versa). The molten material is then discharged naturally into the fluid flow.

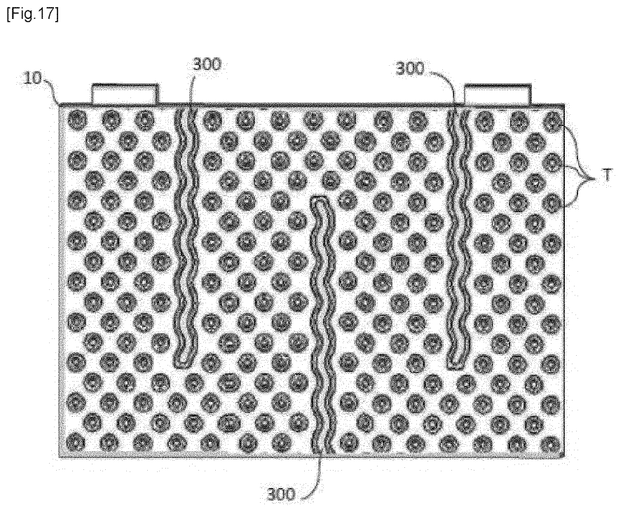

In another embodiment variant illustrated in FIGS. 17 to 21, the turbulators T, T₁, T₂ and/or the rib(s) 300 are formed directly in the wall of at least one large side face 100₁₁, 100₂₁ of the cells 10₁, 10₂, and preferentially in each of the walls of the two large side faces 100₁₁, 100₁₂, 100₂₁, 100₂₂. The turbulators T and/or the rib(s) 300 project from the wall of a large side face 100₁₁ of a cell 10₁ and extend toward the wall of the large side face 100₂₂ of another adjacent cell 10₂.

The turbulators T and/or the rib(s) 300 may be formed, for example, by die-cutting, stamping, molding or machining the walls of the large side faces 100₁₁, 100₁₂, 100₂₁, 100₂₂.

To preserve the electrical insulation of each cell, the turbulators T and/or the rib(s) 300 are advantageously covered with an electrically insulating film, for example a film manufactured from aramid fiber, polycarbonate resin or a polyimide film (Kapton®).

In FIG. 17, the ribs 300 are corrugated to increase turbulence. The corrugation pitch corresponds to the turbulator pitch T. This configuration may apply to all the embodiments presented in the description.

As the cell walls are generally made of a thermally conductive material and/or a material which has a relatively high thermal conductivity, the turbulators have the dual function of disrupting the fluid flow and increasing the heat exchange surface area. To avoid or limit heat transfer from one cell to another in the event of thermal runaway, several solutions described hereinbelow can be envisaged.

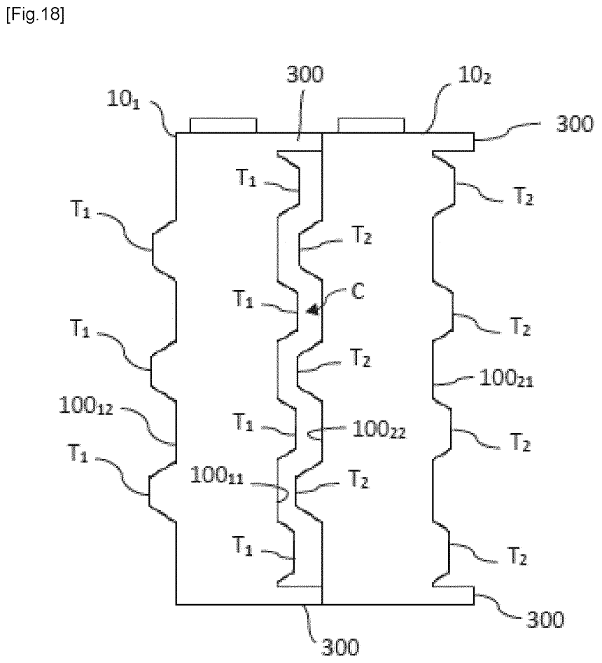

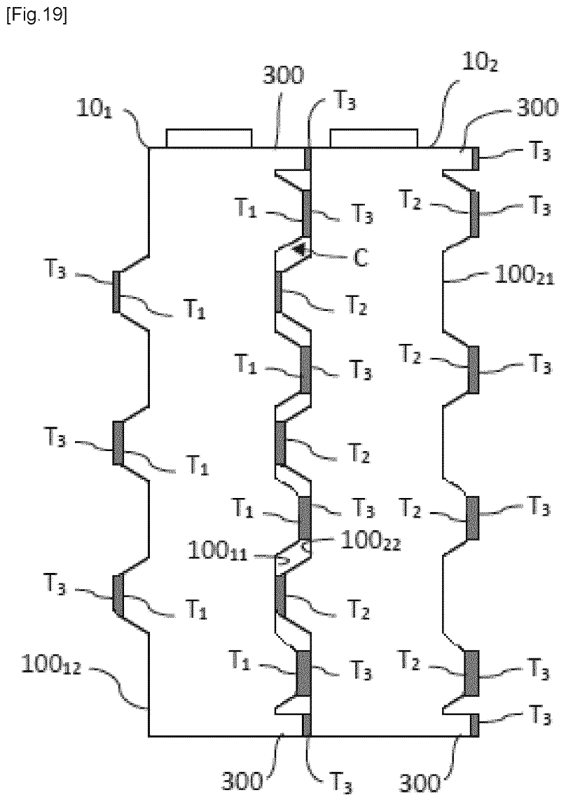

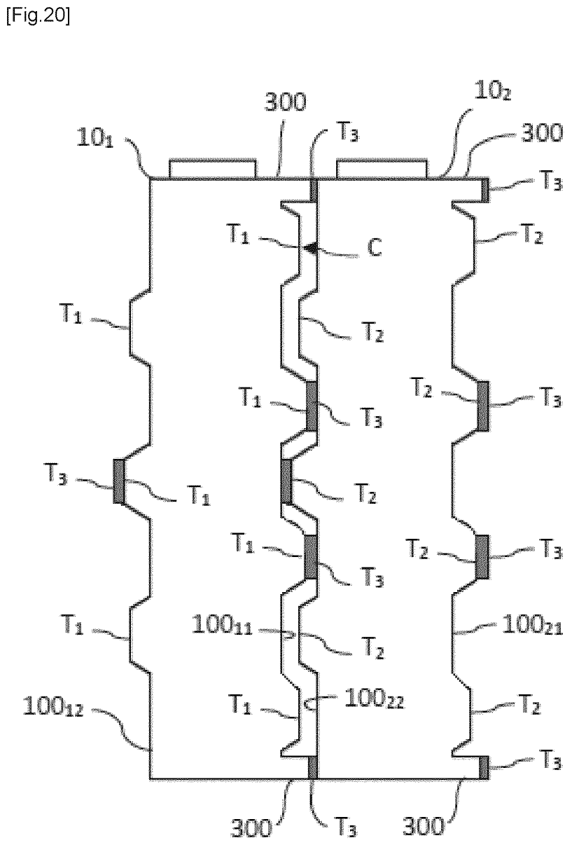

In FIG. 18, the height of the turbulators T₁, T₂ is less than the thickness of the fluid blade flowing in circuit C or, in an equivalent manner, less than the height of the ribs 300 or less than the distance separating two adjacent cells 10₁, 10₂. The turbulators T₁ of a cell 10₁ are thus not in contact with the wall of the large side face 100₂₂ of another adjacent cell 10₂, so that in the event of thermal runaway of a cell 10₁, the heat is not transferred to the adjacent cell 10₂ (or vice versa). When the turbulators T₁, T₂ are formed in each of the walls of the two large side faces 100₁₁, 100₁₂, 100₂₁, 100₂₂, the turbulators T₁ of one large face 100₁₁ are advantageously staggered with the turbulators T₂ of the adjacent large face 100₂₂, so that said turbulators are not in contact with each other and heat cannot be transferred from one cell to the other.

In FIG. 19, the height of the turbulators T₁, T₂ corresponds (i.e. is equal to) the thickness of the fluid blade flowing in circuit C or, in an equivalent manner, corresponds to the height of the ribs 300 or to the distance separating two adjacent cells 10₁, 10₂. The turbulators T₁ (or, respectively, T₂) of a cell 10₁ are thus in contact with the wall of the large side face 100₂₂ (or, respectively, 100₁₁) of another adjacent cell 10₂ (or, respectively, 10₁). The turbulators T₁, T₂ and/or the rib(s) 300 may be formed in the wall of only one of the large side faces of the cells or in both. Contact between the turbulators T₁, T₂ and/or the rib(s) 300 and the adjacent large side face is preferentially made by a thermal switch T₃ so as to thermally insulate said turbulators from said wall of the large side face. The thermal switch T₃ is of the type described previously.

In FIG. 20, certain turbulators T₁ of a cell 10₁ are in contact with the wall of the large side face 100₂₂ of another adjacent cell 10₂ and other turbulators of said cell 10₁ are thus not in contact with said wall of the large side face 100₂₂. This solution allows the contact surface area of the spacer 3 with an adjacent cell to be increased locally in the zones in which the swelling of the cells under the effect of their heating is maximal (notably in the center of the cells).

In FIG. 21, the height of the turbulators T₁, T₂ is such that they are not in contact with the wall of the large side face 100₂₂ or, respectively, 100₂₁, of another adjacent cell 10₂ or, respectively, 10₁. However, the turbulators T₁ of a cell 10₁ are arranged opposite the turbulators T₂ of the adjacent cell 10₂ so that said turbulators are in contact with each other. Contact between the turbulators T₁, T₂ is preferentially made by a thermal switch T₃ so as to thermally isolate the cells. The thermal switch T₃ is of the type described previously.

The arrangement of the various elements and/or means and/or steps of the invention, in the embodiments described hereinabove, must not be interpreted as demanding such an arrangement in all implementations. In any case, it will be appreciated that various modifications may be made to these elements and/or means and/or steps without departing from the spirit and scope of the invention.

Furthermore, one or more of the features set out in just one embodiment may be combined with one or more other features set out in just one other embodiment. Likewise, one or more features set out in just one embodiment may be generalized to the other embodiments, even if this or these features are described only in combination with other features.

1. A device for spacing battery cells of a vehicle battery pack, comprising:
a spacer configured to be in contact with adjacent large side faces of said cells, wherein said spacer comprises:
a flow zone arranged to be situated opposite the adjacent large side faces of the cells and to extend over a majority of said large faces, and
one or more ribs extending into the flow zone, the one or more ribs are arranged so as to form at least one forced-circulation circuit for a heat-transfer fluid between said cells, so that the fluid is in contact with the two adjacent large side faces of said cells,
wherein the forced-circulation circuit comprises an inlet and an outlet; and
turbulators present in the flow zone, along the forced-circulation circuit, so as to create turbulence in the flow of the heat-transfer fluid between the inlet and the outlet of said forced-circulation circuit, which turbulators are set in relief and extend in a height of the ribs.

2. (canceled)

3. (canceled)

4. (canceled)

5. The device as claimed in claim 1, in which the turbulators have:
a first part suitable for being in contact with a large side face of a cell;
a second part suitable for being in contact with a large side face of another adjacent cell; and
a thermal switch to thermally insulate the first part from the second part.

6. The device as claimed in claim 5, in which the turbulators and/or the one or more ribs are formed directly on a wall of at least one large side face of the cells.

7. (canceled)

8. The device as claimed in claim 5, in which a thermal switch thermally insulates the turbulators and/or the one or more ribs from a wall of the large side face of an adjacent cell.

9. (canceled)

10. The device as claimed in claim 5, in which the first part and the second part of the turbulators are made of a thermally conductive material.

11. The device as claimed in claim 5, in which the thermal switch forms a support to which the first part and the second part are attached.

12. The device as claimed in claim 5,
wherein the thermal switch forms a physical interface between the first part and the second part,
wherein said switch being made of a material having a melting point below a threshold temperature, so that when the temperature of the first part and/or of the second part reaches said threshold temperature,
wherein said switch melts without leaving any physical contact between said first part and said second part, which melting point is less than or equal to 200° C.

13. The device as claimed in claim 5, comprising variable turbulator densities along the forced-circulation circuit, wherein the turbulator density at the outlet of the forced-circulation circuit is greater than the turbulator density at the inlet of said circuit.

14. The device as claimed in claim 5, one in which the forced-circulation circuit comprises fluid circulation sections of variable width, gradually or continuously, from the inlet to the outlet.

15. (canceled)

16. A system for thermal regulation of a vehicle battery pack, comprising:
a housing comprising a heat-transfer fluid circulation circuit, which housing is capable of housing a battery pack; and
the device as claimed in claim 1.

17. A cooling facility comprising:
the system as claimed in claim 16
a battery pack comprising N adjacent battery cells, including two end cells each arranged at one end wall of the housing, N being an integer greater than 3; and
wherein the system comprising at least N−1 spacers.

18. The cooling facility as claimed in claim 17,
wherein one spacer is installed between each cell that is adjacent to another cell,
wherein one spacer is installed between each end wall of the housing and the end cell a large side face of which is adjacent to said wall,
wherein the spacers comprise:
a flow zone arranged to be situated opposite the adjacent large side faces of the cells and to extend over the majority of said large faces,
one or more ribs extending into the flow zone, the one or more ribs are arranged so as to form at least one forced-circulation circuit for the heat-transfer fluid between said cells, so that the fluid is in contact with the two adjacent large side faces of said cells, the forced-circulation circuit comprises an inlet and an outlet,
wherein all the large side faces of the cells are cooled by a forced-circulation circuit.

19. The cooling facility as claimed in claim 17
wherein the battery pack comprises two or more rows of cells placed side by side,
wherein the ribs of each spacer are formed so as to create one or more forced-circulation circuits, each said circuit having one or more arched links on the two large side faces of two cells arranged side by side,
wherein each spacer comprises a median rib which extends in the height of said cells and which is installed, in use, between side edges of said large side faces, so that said median rib fills the space between the two cells and forms a seal between said cells, apertures being provided in the median rib so as to allow fluid flow between the large side faces of two cells arranged side by side.
